(19) United States
(12) Patent Application Publication
(10) Pub. No.: US 2014/0093286 A1
(43) Pub. Date: Apr. 3, 2014

(54) IMAGE FORMING APPARATUS

(71) Applicant: Wakana ITOH, Kanagawa (JP)

(72) Inventor: Wakana ITOH, Kanagawa (JP)

(21) Appl. No.: 13/975,617

(22) Filed: Aug. 26, 2013

(30) Foreign Application Priority Data
Sep. 28, 2012 (JP) 2012-216279

(51) Int. Cl. G03G 15/01

(52) U.S. Cl. CPC G03G 15/14
USPC 399/302

(57) ABSTRACT

An image forming apparatus having a system speed of from 400 to 2,000 mm/sec, including an endless rotational member having an elastic layer, to transfer a sheet-shaped medium bearing a toner image; and a transfer electric field forming member facing the rotational member, to form a transfer electric field relative to the sheet-shaped medium. A toner of the toner image includes a parent particulate material formed of a colored particulate material granulated by emulsifying or dispersing a toner material solution in an aqueous medium to prepare an emulsion or a dispersion, and removing a solvent therefrom; an external additive on the surface of the parent particulate material; and a charge controlling agent. The external additive is an inorganic particulate material, polymeric particulate material or a polymeric particulate material formed of a thermoplastic resin. The toner is subjected to a surface treatment with a fluidizer to be uniformly charged.

### CROSS-REFERENCE TO RELATED APPLICATIONS

This patent application is based on and claims priority pursuant to 35 U.S.C. §119 to Japanese Patent Application No. 2012-216279, filed on Sep. 28, 2012, in the Japan Patent Office, the entire disclosure of which is hereby incorporated by reference herein.

### BACKGROUND

1. Technical Field

The present invention relates to an image forming apparatus such as copiers, printers and facsimile, and more particularly to a configuration preventing production of defective images when images are formed at high speed.

2. Description of the Related Art

Recently, a need exists for an electrophotographic image forming apparatus such as copiers, printers and facsimiles, which can produce high quality images at a high speed. In order to fulfill such a need, high speed image forming apparatuses capable of forming images at a speed of from 400 mm/sec to 2,000 mm/sec have been marketed.

When images are formed at high speed, a part of a toner image occasionally comes out due to defective transfer.

This is more noticeable when images are formed on a recording material having concavities and convexities.

When the recording material has concavities and convexities, contact between a transfer member forming a transfer electric field and the recording material deteriorates and there is a part where an electric field is not effectively activated, resulting in an image a toner image is partially untransferred to (a void image).

This largely deteriorates image quality.

It is thought this is caused by the followings.

First, the contact between a transfer member and the recording material deteriorates.

Second, adherence of a toner is strengthened due to its deterioration. Third, a toner deteriorates in fluidity. Fourth, a toner deteriorates in chargeability.

Japanese published unexamined applications Nos. JP-2001-42666-A, JP-2006-308979-A and JP-2009-288536-A disclose a method of using an elastic body for the transfer member or a method of pressing a toner for the purpose of increasing contact between the transfer member and the recording material.

Japanese published unexamined applications Nos. JP-2007-4081-A, JP-2008-209848-A and JP-2005-233989-A disclose a method of controlling a surface resistivity of the transfer member in addition to the method of increasing contact between the transfer member and the recording material. Japanese published unexamined applications Nos. JP-2002-268285-A and JP-2008-268435-A disclose a method of adding an external additive to a toner to decrease adherence thereof.

As disclosed in Japanese published unexamined applications Nos. JP-2001-42666-A, JP-2006-308979-A and JP-2009-288536-A, when an elastic body is used for the transfer member for the purpose of increasing contact between the transfer member and the recording material, e.g., it is probable that an endless transfer belt formed of a rubber extends and contracts an image thereon. Particularly when plural color images are transferred, a position where the images are overlapped is shifted due to extension and contraction, resulting in color shift.

Even the methods disclosed in Japanese published unexamined applications Nos. JP-2007-4081-A, JP-2008-209848-A, JP-2005-233989-A, JP-2002-268285-A and JP-2008-268435-A do not prevent images from extending and contacting, resulting in probable color shift after all.

Because of these reasons, a need exist for a high-speed image forming apparatus including a configuration preventing a toner from coming out of an image (a void image) to improve image quality.

### SUMMARY

Accordingly, one object of the present invention is to provide a high-speed image forming apparatus including a configuration preventing a toner from coming out of an image (a void image) to improve image quality.

These objects and other objects of the present invention, either individually or collectively, have been satisfied by the discovery of an image forming apparatus having a system speed of from 400 to 2,000 mm/sec, including an endless rotational member having an elastic layer, to transfer a sheet-shaped medium bearing a toner image; and a transfer electric field forming member facing the rotational member, to form a transfer electric field relative to the sheet-shaped medium. A toner of the toner image includes a parent particulate material formed of a colored particulate material granulated by emulsifying or dispersing a toner material solution (oil phase) in an aqueous medium (aqueous phase) to prepare an emulsion or a dispersion, and removing a solvent therefrom; an external additive on the surface of the parent particulate material; and a charge controlling agent. The external additive is an inorganic particulate material, polymeric particulate material or a polymeric particulate material formed of a thermoplastic resin. The toner is subjected to a surface treatment with a fluidizer to be uniformly charged.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a diagram for explaining a charge distribution of a toner;

FIG. 3 is a schematic view illustrating a transfer electric field forming member used in the mage forming apparatus in FIG. 1;

FIG. 4 is a schematic view illustrating an embodiment of apparatus used for obtaining the transfer electric field forming member in FIG. 3;

FIG. 5 is schematic view illustrating one of processes of obtaining the transfer electric field forming member in FIG. 3; and

FIGS. 6A and 6B are schematic views illustrating adherence of a toner to a recording medium in the embodiment of the image forming apparatus of the present invention.

### DETAILED DESCRIPTION

The present invention provides a high-speed image forming apparatus including a configuration preventing a toner from coming out of an image (a void image) to improve image quality.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

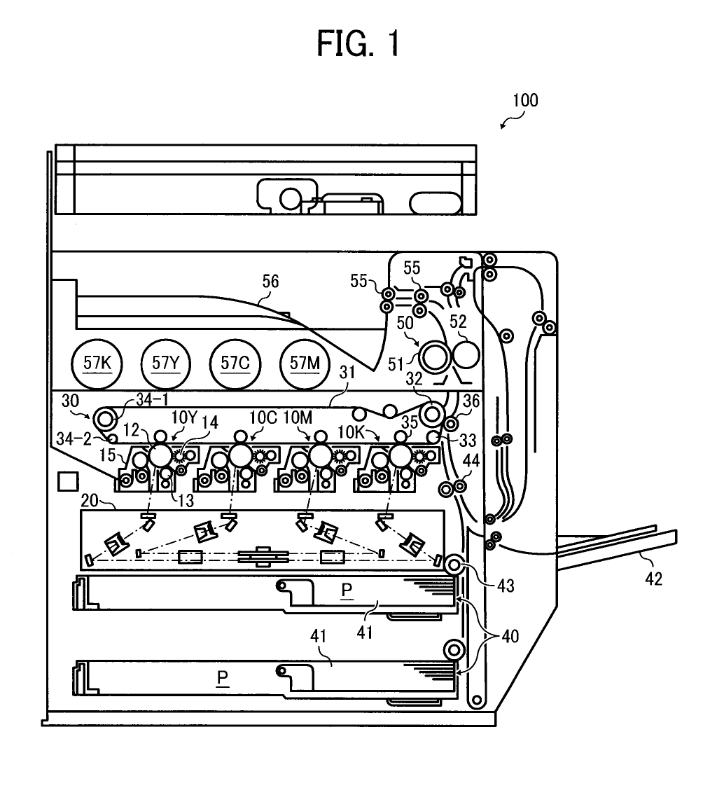

FIG. 1 is a schematic view illustrating an embodiment of the image forming apparatus 100 of the present invention.

The image forming apparatus 100 includes image formers for four colors. i.e., 10Y (yellow), 10C (cyan), 10M (magenta) and 10K (black) detachable from relative image forming stations, an optical unit 20 as an irradiator capable of irradiating a laser beam, a transfer electric field forming unit 30, a paper feed unit 40 and a fixing unit 50.

Each of the image formers 10Y (yellow), 10C (cyan), 10M (magenta) and 10K (black) has the same configuration integrally including a photoreceptor drum 12 as an image bearer, a charger 13 charging the photoreceptor drum 12 and a cleaner 14 removing a developer remaining on the photoreceptor drum 12. An image developer 15 developing a latent image formed on the photoreceptor drum 12 is connected to each f the image formers. Each of the image formers is detachable from the image forming apparatus in an opening and closing direction of an openable plate mentioned later (rotational axial direction of the photoreceptor)

The transfer electric field forming unit 30 includes a transfer belt 31 which is an endless rotational member as a transfer electric field forming member, and four rollers 32, 33 34-1 and 34-2 rotatably supporting the transfer belt 31. Further, the transfer electric field forming unit 30 includes a first transfer roller 35 equivalent to a transfer electric field forming member for transferring a toner image formed on each of the photoreceptor drum 12 onto the transfer belt 31, and a second transfer roller 36 equivalent to a transfer electric field forming member for further transferring the toner image transferred on the transfer belt 31 onto a recording paper P.

The paper feed unit 40 includes a paper feed roller 43 and a registration roller 44 transferring a recording paper P to a second transfer area from a paper feed cassette 41 or a manual paper feed tray 42.

The fixing unit 50 includes a fixing roller 51 and a pressure roller 52, and applies a heat and a pressure to a toner image on a recording paper P to fix the toner image thereon.

First, in the image former 10Y, after the photoreceptor drum 12 is uniformly charged by the charger 13, the optical unit 20 irradiates the surface of the photoreceptor drum 12 with a laser beam to form an electrostatic latent image thereon, and the image developer 15 develops the electrostatic latent image to form a toner image.

The toner image formed on the photoreceptor drum 12 is transferred onto the transfer belt 31 by the first transfer roller 35. The photoreceptor drum 12 having transferred the toner image is cleaned by the cleaner 14, and ready for the following image formation.

A residual toner collected by the cleaner 14 is stored in an unillustrated waste toner collection bottle located in a takeoff direction of the image former (rotational axial direction of the photoreceptor drum 12). The waste toner collection bottle is detachable from the image forming apparatus to be exchanged when filled.

The same image forming process is performed in each of the image formers 10C, 10M and 10K as well to form each color toner image, and is sequentially overlapped on the previously formed toner image.

Meanwhile, a recording paper P is transferred to the second transfer area by the paper feed cassette 41 or the manual paper feed tray 42, and the toner image formed on the transfer belt 31 is transferred onto the recording paper P by the second transfer roller 36.

The recording paper P the toner image is transferred on is transferred to the fixing unit 50, the toner image is fixed at a nip between the fixing roller 51 and the pressure roller 52, and discharged onto a paper discharge tray 56 by a paper discharge roller 55.

Each of toner bottles 57Y, 57C, 57M and 57K is rotated to feed a new toner to each of the image formers 10Y, 10C, 10M and 10K through a pipe.

A toner having the following compositions is used in the image forming apparatus 100.

The toner of the present invention is composed of a parent particulate material formed of a colored particulate material granulated by emulsifying or dispersing a toner material solution (oil phase) in an aqueous medium (aqueous phase) to prepare an emulsion or a dispersion, and removing a solvent therefrom.

An external additive may be added to the surface of the parent particulate material for the purpose of assisting fluidity, developability, chargeability and cleanability of the toner. Inorganic particulate materials such as large-size silica, small-size silica and titanium oxide are preferably used as the external additive.

The external additive preferably has a particle diameter of from 25 nm to 2 μm, and particularly the large-size silica preferably has a particle diameter of from 25 nm to 270 nm and a coverage over the parent particulate material of from 5 to 45%.

The toner preferably has a BET specific surface area of from 20 to 500 m²/g and includes the inorganic particulate material in an amount of from 0.1 to 12 parts by weight. A ratio of a total weight of the large-size silica and the small-size silica to that of the titanium oxide (large-size silica+small-size silica)/titanium oxide) is preferably from 1 to 10.

Specific examples of the inorganic particulate materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

In addition, particles of polymers such as polymers prepared by a soap-free emulsion polymerization or a suspension polymerization (e.g., polystyrene, and (meth)acrylic ester copolymers), polycondensation polymers such as silicone resins, benzoguanamine resins, and nylon resins, and thermosetting polymers can also be used as external additives.

The content of a charge controlling agent in the toner of the present invention is determined depending on the variables such as choice of binder resin, presence of additives, and dispersion method. In general, the content of a charge controlling agent is preferably from 0.1 parts to 10 parts by weight, and more preferably from 0.2 parts to 5 parts by weight, per 100 parts by weight of the binder resin included in the toner.

When the content is greater than 10 parts by weight, the charge quantity of the toner excessively increases, thereby excessively increasing the electrostatic attraction between the developing roller and the toner, resulting in deterioration of fluidity and decrease of image density. When a charge controlling agent is included in the toner, a method in which the charge controlling agent is preliminarily kneaded together with a colorant master batch or a binder resin, the mixture is dissolved in a solvent, and the solution is added when other toner components such as binder resins and release agents are mixed to prepare an oil phase liquid; a method in which the charge controlling agent is directly added to a solvent together with other toner components such as binder resins and release agents to prepare an oil phase liquid; a method in which after preparing toner particles, the charge controlling agent is mixed with the toner particles to be fixed thereto, and the like method can be used.

Suitable examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc.

Specific examples of the marketed charge controlling agents include BONTRON 03 (Nigrosine dye), BONTRON P-51 (quaternary ammonium salt), BONTRON S-34 (metal-containing azo dye), BONTRON E-82 (metal complex of oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, a quaternary ammonium group, etc.

It is possible to subject toner particles to a surface treatment using a fluidizer so that the resultant toner has a good combination of fluidity and charge property even under high humidity conditions.

Specific examples of the treatment agents include silane coupling agents, silane coupling agents having a fluoroalkyl group, silylating agents, organic titanate coupling agents, aluminum coupling agents, silicone oils, modified silicone oils, etc.

The toner of the present invention optionally includes a colorant. Suitable materials for use as the colorant include known dyes and pigments. Specific examples of such dyes and pigments include carbon black, Nigrosine dyes, black iron oxide, NAPHTHOL YELLOW S, HANSA YELLOW 10G, HANSA YELLOW 5G, HANSA YELLOW G, Cadmium Yellow, yellow iron oxide, loess, chrome yellow, Titan Yellow, polyazo yellow, Oil Yellow, HANSA YELLOW GR, HANSA YELLOW A, HANSA YELLOW RN, HANSA YELLOW R, PIGMENT YELLOW L, BENZIDINE YELLOW G, BENZIDINE YELLOW GR, PERMANENT YELLOW NCG, VULCAN FAST YELLOW 5G, VULCAN FAST YELLOW R, Tartrazine Lake, Quinoline Yellow LAKE, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED F2R, PERMANENT RED F4R, PERMANENT RED FRL, PERMANENT RED FRLL, PERMANENT RED F4RH, Fast Scarlet VD, VULCAN FAST RUBINE B, Brilliant Scarlet LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE RS, INDANTHRENE BLUE BC, Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is preferably from 1% to 15% by weight, and more preferably from 3% to 10% by weight of the toner.

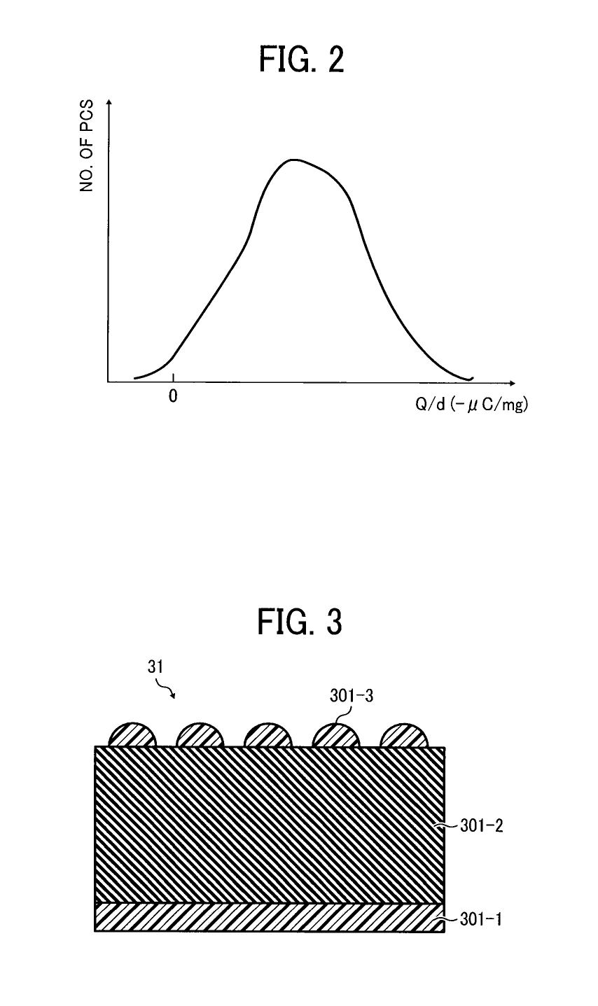

FIG. 2 is a charge distribution of a toner used in the embodiment of the present invention.

The toner has a stable charge amount of from −100 to 10 μc/mg.

FIG. 3 is a schematic view illustrating a layer structure of the transfer electric field forming member used in the in the embodiment of the present invention.

In FIG. 3, on a flexuous and stiff substrate 301-1, a flexible elastic body 301-2 is layered. A layer of a spherical particulate resin 301-3 is formed on the surface of the elastic body 301-2.

The substrate 301-1 is formed of a resin including an electrical resistance adjuster.

In terms of non-flammability, fluorine-containing resins such as PVDF and ETFE, polyimide resins or polyamideimide resins are preferably used as the resin. Particularly, the polyimide resins or polyamideimide resins are more preferably used in terms of mechanical strength (high elasticity).

The electrical resistance adjuster includes metal oxides, carbon black, ion conductivizers, conductive polymers, etc.

Specific examples of the metal oxides include zinc oxide, tin oxide, zirconium oxide, aluminum oxide, silicon oxide, etc. Surface-treated metal oxides having better dispersibility can also be used.

Specific examples of the carbons black include ketjen black, furnace black, acetylene black, thermal black, gas black, etc.

Specific examples of the ion conductivizers include tetraalkylammonium salts, trialkylbenzylammonium salts, alkylsulfonic acid salts, alkylbenzenesulfonic acid salts, alkylsulfates, glycerin fatty acid esters, sorbitan fatty acid esters, polyoxyethylenealkylamine, polyoxyethylene fatty alcohol esters, alkylbetaines, lithium perchlorate, etc. These can be sued alone or in combination.

The electrical resistance adjusters of the present invention are not limited to the above-mentioned compounds. A coating liquid including at least a resin for preparing the transfer electric field forming member may further include additives such as a dispersion aid, a reinforcing agent, a lubricant and an antioxidant when necessary.

The transfer electric field forming member preferably includes the electrical resistance adjuster so as to have a surface resistivity of from 1×10⁸ to 1×10¹³ Ω/□, and a volume resistivity of from 1×10⁶ to 1×10¹² Ω·cm. The content of the electrical resistance adjuster should be in such a range that the layer is neither brittle nor cracked.

Namely, a coating liquid in which the contents of the resin component, e.g., polyimide resin precursors or polyamide imide resin precursor, and the electrical resistance adjuster are properly controlled is preferably used to prepare a transfer electric field forming member having a good balance between electrical properties (surface resistivity and volume resistivity) and mechanical strength.

The content of the electrical resistance adjuster when being carbon black in the coating liquid is preferably from 10 to 25% by weight, and more preferably from 15 to 20% by weight per 100% by weight of solid contents in the liquid. The content of the electrical resistance adjuster when being metal oxide in the coating liquid is preferably from 1 to 50% by weight, and more preferably from 10 to 30% by weight per 100% by weight of solid contents in the liquid.

When the content is less than the range, the effect of the electrical resistance adjuster is not sufficiently obtained. When greater than the range, the transfer electric field forming member deteriorates in mechanical strength.

The elastic body 301-2 can be formed of conventional resins, elastomers, rubbers, etc. The elastomers and rubbers having sufficient flexibility (elasticity) to fully exert an effect of the embodiment of the present invention are preferably used.

The elastomers include thermoplastic elastomers such as polyester elastomer, polyamide elastomers, polyether elastomers, polyurethane elastomers, polyolefin elastomers, polystyrene elastomers, polyacrylic elastomers, polydiene elastomers, silicone-modified polycarbonate elastomers, fluorine-containing copolymer elastomers; and thermosetting elastomers such as polyurethane elastomers, silicone-modified epoxy elastomers and silicone-modified acrylic elastomers.

The rubbers include isoprene rubbers, styrene rubbers, butadiene rubbers, nitrile rubbers, ethylene-propylene rubbers, butyl rubbers, silicone rubbers, chloroprene rubbers, acrylic rubbers, chlorosulfonated polyethylene rubbers, fluorine-containing rubbers, urethane rubbers, hydrin rubbers, etc.

The softer, the better the elastomers or the rubbers to follow concavities and convexities on papers such as LEATHAC paper.

In this embodiment, the thermosetting materials are more preferably used than the thermoplastic materials because a spherical particulate resin layer is formed thereon, and the thermosetting materials well adhere to resins. A vulcanized rubber is preferably used as well.

In addition to the above materials, a resistivity adjuster for adjusting electrical properties, a flame retardant for non-flammability, an antioxidant, a stiffener, a filler, a vulcanization accelerator, etc. are included when necessary.

As the resistivity adjuster, it is preferable carbon black or metal oxides are not used so much because of impairing flexibility. Ion conductivizers and conductive polymers are effectively used. These can be used in combination.

The elastic body 301-2 preferably has a surface resistivity of from 1×10⁸ to 1×10¹³ Ψ/□, and a volume resistivity of from 1×10⁶ to 1×10¹² Ω·cm.

The elastic body 301-2 preferably has a thickness of from 200 μm to 2 mm. When too thin, followability to the surface of a transfer medium and transfer pressure lower. When too thick, the belt 31 is so heavy that it is likely to bend and unstably runs. In addition, the belt is likely to have a crack at a flexure contacting a roller suspending the belt.

The spherical particulate resin 301-3 is formed of, but not limited to, acrylic resins, melamine resins, polyamide resins, polyester resins, silicone resins, fluorine-containing resins, etc. The surface of the particulate resin may be treated with different materials. The particulate resin includes rubber materials. The surface of the rubber-made particulate material may be coated with a hard resin. The spherical particulate resin 301-3 may be hollow or porous.

The silicone resin is most preferably used because of having lubricity and imparting releasability and abrasion resistance to a toner.

The spherical particulate resin 301-3 is preferably formed spherical by polymerization methods, etc. with the resin. The higher the sphericity, the more preferable.

The spherical particulate resin 301-3 preferably has a volume-average particle diameter of from 0.5 to 5.0 μm, and is monodispersed, having a sharp particle diameter distribution.

When too small, the transferability is not sufficiently improved. When too large, the surface roughness and a gap between the particles become large, resulting in defective transfer of a toner and defective cleaning.

Further, the spherical particulate resin 301-3 is mostly insulative, and when too large, charge potential remains and accumulates, resulting in image distortion when images are continuously produced.

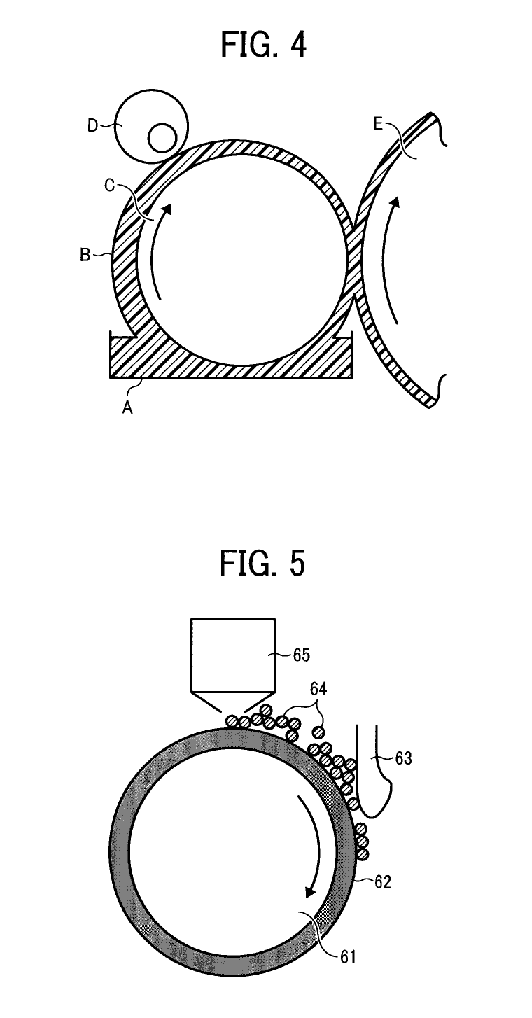

FIG. 4 is a schematic view illustrating an apparatus for coating the substrate and the elastic body in this embodiment. A method of preparing the belt of this embodiment is explained.

First, a method of preparing the substrate is explained.

A method of preparing the substrate using a coating liquid including at least a resin, i.e., the polyimide precursor or the polyamideimide precursor is explained.

The coating liquid is coated on the surface of a cylindrical substrate by spiral coating with a nozzle or a dispenser, die coating with a wide die or roll coating with a roll. The roll coating is explained.

In FIG. 4, A is a coating pan for reserving a defoamed precursor liquid as a coating liquid, B is a precursor liquid, C is a coating roller continuously drawing the coating liquid from the coating pan A. D is a regulation roller for the coating liquid to have a predetermined thickness in a gap with the coating roller C. E is a cylindrical substrate (metallic mold) the coating liquid having a predetermined thickness is transferred onto.

First, the fully defoamed precursor liquid is placed in the coating pan. The liquid preferably has a viscosity of from 0.5 to 10 Pa-s with an organic solvent.

Next, the bottom of the coating roller is dipped in the coating pan the liquid was placed in, and the coating roller is rotated at a low peripheral speed of from 10 to 100 mm/sec to draw the liquid.

Then, the regulation roller located above the coating roller regulates the thickness of the liquid on the coating roller in a gap therewith. The thickness is preferably twice as much as that transferred onto the cylindrical substrate.

Next, the cylindrical substrate E is put close to the coating roller C while slowly rotated leaving a gap not larger than the thickness of the liquid on the coating roller. The liquid on the coating roller is transferred onto the cylindrical substrate E rotating in the same direction of the coating roller C (clockwise in FIG. 4) to have a predetermined thickness thereon.

After coated, the cylindrical substrate E is gradually heated while rotated to vaporize a solvent in the coated layer at from 80 to 150° C. In this process, it is preferable that the atmospheric vapor such as vaporized solvent is efficiently circulated to remove.

When a self-supportive layer is formed, the cylindrical substrate E the layer is formed on is placed in a heating (firing) furnace and heated in stages, and heated (fired) at high temperature of from 250 to 450° C. finally to fully imidize or polyamideimidize the polyimide precursor or the polyamideimide precursor.

After the substrate is fully cooled, an elastic body is layered thereon. A rubber coating liquid including a rubber dissolved in an organic solvent is coated on the substrate, and then the solvent is dried and vulcanized.

Coating methods include the same methods used for forming the substrate, i.e., spiral coating, die coating and roll coating. The die coating and the spiral coating are preferably used to form a thick elastic body having good transferability on concave and convex transfer media. The spiral coating is explained.

While the substrate is rotated in a circumferential direction, the rubber coating liquid is continuously fed to a round or a wide nozzle and the nozzle is moved to an axial direction of the substrate to spirally coating the liquid on the substrate. The coating liquid spirally coated on the substrate is dried while leveled at a predetermined rotation speed and temperature.

FIG. 5 is a schematic view illustrating an apparatus feeding the spherical particulate material.

In FIG. 5, 61 is a substrate, 62 is a belt including the substrate and the elastic body prepared in the above processes, 63 is a pressing member, 64 is a particulate resin and 65 is a powder feeder.

When the belt 62 fully leveled is rotated while wound round the substrate 61, the spherical particulate materials fed from the powder feeder 65 are uniformly dispersed on the surface of the belt 62. The spherical particulate materials uniformly dispersed on the surface of the belt 62 are pressed against the surface of the elastic body by the pressing member 63.

The pressing member 63 buries the particulate materials in the elastic body and removes the extra particulate materials. After a uniform particulate material layer is formed, it is heated at a predetermined temperature and a predetermined time to be cured to form an elastic body. After fully cooled, the elastic body together with the substrate is released from the metallic mold to prepare a desired transfer electric field forming member.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Example 1

### Preparation of Coating Liquid for Substrate

First, a dispersion including carbon black (Special Black 4 from Evonik Degussa GmbH dispersed in N-methyl-2-pyrrolidone by beads mill was well mixed in polyimide varnish (U-varnish A from UBE INDUSTRIES, LTD.) so as to include carbon black in an amount of 17% by weight based on total weight of a polyamic acid solid content to prepare a coating liquid.

### <Preparation of Transfer Electric Field Forming Member>

A blasted metallic cylindrical substrate having an outer diameter of 340 mm and a length of 360 mm was used as a mold to be set on a roll coater.

Next, the coating liquid was placed in a pan and drawn at a rotational speed of 40 mm/sec with a gap of 0.6 mm between a regulation roller and a coating roller to control the thickness of the coating liquid on the coating roller.

Then, the cylindrical substrate was put close to the coating roller at a rotational speed of 30 mm/sec with a gap of 0.4 mm with the coating roller to uniformly transfer the coating liquid thereon onto the cylindrical substrate. The coated cylindrical substrate was placed in a hot air circulation drier and gradually heated up to 110° C. and heated thereat for 30 min, and further heated at 200° C. for 30 min and the rotation of the cylindrical substrate was stopped.

Then, the cylindrical substrate was placed in a high-temperature heating (firing) furnace and heated in stages up to 320° C., and heated (fired) thereat for 60 min.

### <Formation of Elastic Body on Substrate>

The following materials were fully kneaded by a biaxial kneader to prepare a rubber composition.

### <Elastic Body Composition>

| | | |
|---|---|---|
| Acrylic rubber | Nipol AR12 from ZEON CORP. | 100 |
| Stearic acid | Beads stearic acid TSUBAKI from | 1 |
| | NOF CORP. | |
| Red | Novaexcel 140F from | 10 |
| phosphorus | RIN KAGAKU KOGYO Co., Ltd. | |
| Aluminum | HIGILITE H42M from | 60 |
| hydroxide | SHOWA DENKO K.K. | |
| Crosslinker | Diak. No 1 (hexamethylenediamine | 0.6 |
| | carbamate from DuPont Dow Elastomers Japan) | |
| Crosslinking | VULCOFAC ACT55 | 1 |
| promoter | (70% salt of 1,8-diazabicyclo (5,4,0) undecene-7 | |
| | and dibasic acid 30% amorphous silica from | |
| | Safic Alcan) | |
| Conductivizer | QAP-01 (tetrabutylammonium perchlorate | 0.3 |
| | from Japan Carlit Co., Ltd.) | |

Next, the rubber composition was dissolved in an organic solvent (methylisobutylketone) to prepare a rubber solution including a solid content in an amount of 35% by weight. The rubber solution was continuously discharged from a nozzle to be spirally coated on the polyimide base material formed on the cylindrical substrate in an axial direction thereof while rotated. The rubber solution was coated so as to form the final rubber layer having a thickness of 500 μm.

When the rubber solution was evenly spread over the base material, a spherical particulate material 301-3 was coated on the rubber layer by the particulate material applicator in FIG. 4.

A particulate silicone resin (Tospearl 130 from Momentive Performance Materials, Inc., having a volume-average particle diameter of 3.0 μm) was used as the spherical particulate material 301-3.

After the particulate material was coated on the rubber layer, the cylindrical substrate was placed in a hot air circulation drier while rotated and heated for 30 min up to 90° C. at a rate of temperature increase of 4° C./min. Further, the cylindrical substrate was heated for 60 min up to 170° C. at a rate of temperature increase of 4° C./min. After heated, it was gradually cooled. After fully cooled, it was taken out of the mold to prepare a transfer electric field forming member.

After a toner material liquid (oil phase) was emulsified or dispersed in an aqueous medium (phase), a solvent was removed from the emulsified or dispersed toner material liquid to prepare a granulated (colored) particulate material which was a parent particulate material. One part by weight of a chrome-containing metal complex dye was fixed on the parent particulate material as a charge controlling agent.

Next, the parent particulate material was subjected to surface treatment with a silane coupling agent.

One part by weight of a large-size silica, 3 parts by weight of a small-size silica and 2 parts by weight of titanium oxide were mixed with the parent particulate material in HENSCHEL MIXER to prepare a toner. The large-size silica had a particle diameter of 60 nm and a coverage of 7%.

When partially-untransferred toner image (a void image) was evaluated, the system linear speed was 2,000 mm/sec.

### Example 2

The procedure in Example 1 was repeated except for changing the system linear speed from 2,000 to 400 mm/sec.

### Comparative Example 1

The procedure in Example 2 was repeated except for changing the amount of carbon black in the coating liquid for substrate from 17 to 10% by weight.

### Example 3

The procedure in Example 2 was repeated except for changing 17% by weight of carbon black to 20% by weight of a metal oxide.

### Comparative Example 2

The procedure in Example 2 was repeated except for changing the thickness of the rubber layer to 100 μm.

### Comparative Example 3

The procedure in Example 2 was repeated except for changing the volume-average particle diameter of the particulate silicone resin to 10 μm.

### Example 4

The procedure in Example 2 was repeated except for changing the particulate silicone resin to a particulate acrylic resin.

### Example 5

The procedure in Example 2 was repeated except for changing the weight of the large-size silica from 1 to 4 parts by weight and the coverage thereof from 7% to 30%.

### Comparative Example 4

The procedure in Example 2 was repeated except for changing the weight of the large-size silica from 1 to 0.5 parts by weight and the coverage thereof from 7% to 3.5%, and the weight of the small-size silica from 3 to 1 part by weight.

### Example 6

The procedure in Example 2 was repeated except for changing the particle diameter of the large-size silica from 60 to 200 nm.

### Comparative Example 5

The procedure in Example 2 was repeated except for changing the weight of the chrome-containing metal complex dye from 1 to 0.05 parts by weight.

### Comparative Example 6

The procedure in Example 2 was repeated except that the parent particulate material was not subjected to surface treatment with a silane coupling agent.

A print test was made using modified RICOH Pro c901 from Ricoh Company, Ltd.

### [Measurement of System Speed]

One hundred (100) A4 (having a length of 297 mm in paper feeding direction) images were continuously produced. The system speed B was determined by the following formula.

B(mm/sec)=100×209 mm/A sec

wherein A is a time from start to finish.

Fifty thousand (50,000) test images having a printed rate of 6% were produced on A3 size papers. Then, a halftone image was produced on 3 A3 size papers as sample images to visually evaluate the void images. The sample images were compared with a previously prepared reference halftone image and classified into 4 grades, i.e., excellent (E), good (G), fair (F) and poor (P).

The results are shown in Table 1.

TABLE 1

| | SLS | ERA | RLT | PRP | LSSC | LSS + SSS/ | LSSP | CCA | | |
|---|---|---|---|---|---|---|---|---|---|---|
| | (mm/sec) | (Wt %) | (μm) | (μm) | (%) | TO | (μm) | (pbw) | ST | V |
| Example 1 | 2000 | 17 | 500 | 3.0 | 7 | 2.0 | 60 | 1 | Yes | G |
| Example 2 | 400 | 17 | 500 | 3.0 | 7 | 2.0 | 60 | 1 | Yes | G |
| Comparative | 400 | 10 | 500 | 3.0 | 7 | 2.0 | 60 | 1 | Yes | F |
| Example 1 | | | | | | | | | | |
| Example 3 | 400 | 20 | 500 | 3.0 | 7 | 2.0 | 60 | 1 | Yes | G |
| Comparative | 400 | 17 | 100 | 3.0 | 7 | 2.0 | 60 | 1 | Yes | G |
| Example 2 | | | | | | | | | | |
| Comparative | 400 | 17 | 500 | 10.0 | 7 | 2.0 | 60 | 1 | Yes | P |
| Example 3 | | | | | | | | | | |
| Example 4 | 400 | 17 | 500 | 3.0 | 7 | 2.0 | 60 | 1 | Yes | G |
| Example 5 | 400 | 17 | 500 | 3.0 | 30 | 3.5 | 60 | 1 | Yes | G |
| Comparative | 400 | 17 | 500 | 3.0 | 3.5 | 0.75 | 60 | 1 | Yes | P |
| Example 4 | | | | | | | | | | |
| Example 6 | 400 | 17 | 500 | 3.0 | 7 | 2.0 | 200 | 1 | Yes | G |
| Comparative | 400 | 17 | 500 | 3.0 | 7 | 2.0 | 60 | 0.05 | Yes | P |
| Example 5 | | | | | | | | | | |
| Comparative | 400 | 17 | 500 | 3.0 | 7 | 2.0 | 60 | 1 | No | P |
| Example 6 | | | | | | | | | | |

SLS: System Linear Speed
ERA: Content of Electrical Resistance Adjuster
RLT: Rubber Layer Thickness
PRP: Partcile Diameter of Particulate Resin
LSSC: Coverage of Large-Size Silica
LSS: Large-Size Silica
SSS: Small-Size Silica
TO: Titanium Oxide
LSSP: Particle Diameter of Large-Size Silica
CCA: Charge Controlling Agent
pbw: parts by weight
ST: Surface Treatment
V: Void Images

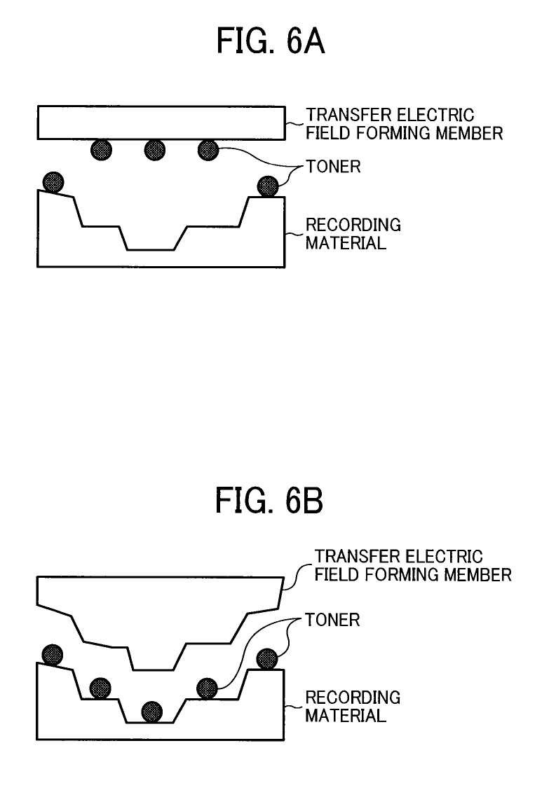

FIGS. 6A and 6B are schematic views illustrating adherence of a toner to a recording medium in the embodiment of the image forming apparatus of the present invention. FIG. 6A shows statuses of Excellent and Good. FIG. 6B shows statuses of Fair and Poor.

In this embodiment, the configurations of a transfer electric field forming member and a toner are specified to improve contact between the transfer electric field forming member and a recording material and transferability of the toner to prevent defective transfer in high-speed operation, i.e., partially-untransferred toner image. This prevents production of defective images and deterioration of image quality.

Having now fully described the invention, it will be apparent to one of ordinary skill in the art that many changes and modifications can be made thereto without departing from the spirit and scope of the invention as set forth therein.

What is claimed is:

1. An image forming apparatus having a system speed of from 400 to 2,000 mm/sec, comprising:
an endless rotational member having an elastic layer, configured to transfer a sheet-shaped medium bearing a toner image; and
a transfer electric field forming member facing the rotational member, configured to form a transfer electric field relative to the sheet-shaped medium,
wherein a toner of the toner image comprises:
a parent particulate material formed of a colored particulate material granulated by emulsifying or dispersing a toner material solution (oil phase) in an aqueous medium (aqueous phase) to prepare an emulsion or a dispersion, and removing a solvent therefrom;
an external additive on the surface of the parent particulate material; and
a charge controlling agent,
wherein the external additive is an inorganic particulate material, polymeric particulate material or a polymeric particulate material formed of a thermoplastic resin, and
is subjected to a surface treatment with a fluidizer to be uniformly charged.

2. The image forming apparatus of claim 1, wherein the transfer electric field forming member comprises:
a first layer formed of a substrate; and
a second layer overlying the first layer, formed of an elastic body on which spherical particulate resins are located to form concavities and convexities thereon, and
wherein the second layer comprises an electrical resistance adjuster as a filler or an additive to adjust electrical resistance.

3. The image forming apparatus of claim 2, wherein the second layer has a surface resistivity of from 1×10⁸ to 1×10¹³ Ω/□, and a volume resistivity of from 1×10⁶ to 1×10¹² Ω·cm.

4. The image forming apparatus of claim 2, wherein the second layer is formed of a resin, an elastomer or a rubber having a thickness of from 200 to 2,000 μm, and the spherical particulate resins have a volume-average particle diameter of from 0.5 to 5.0 μm.

5. The image forming apparatus of claim 2, wherein the first layer comprises a polyimide resin precursor or a polyamideimide precursor and an electrical resistance adjuster.

6. The image forming apparatus of claim 5, the electrical resistance adjuster is carbon black included in the first layer in an amount of from 10 to 25% by weight based on total weight of solid contents.

7. The image forming apparatus of claim 2, wherein the elastic body is formed of a thermosetting material on which the spherical particulate resins are firmly fixed by an effect of a functional group contributing to the thermosetting reaction.

8. The image forming apparatus of claim 1, wherein the toner has the shape of almost a sphere.

9. The image forming apparatus of claim 1, wherein the external additive has a particle diameter of from 2 nm to 2 μm.

10. The image forming apparatus of claim 1, wherein the external additive comprises large-size silica having a particle diameter of from 25 to 270 nm.

11. The image forming apparatus of claim 10, wherein the large-size silica has a coverage of from 5 to 45% over the parent particulate material.

12. The image forming apparatus of claim 1, wherein the external additive comprises large-size silica, small-size silica and titanium oxide in an amount of from 0.1 to 12 parts by weight per 100 parts by weight of the toner, and a weight ratio (large-size silica+small-size silica/titanium oxide) of total of the large-size silica and the small-size silica to the titanium oxide of from 1 to 10.

13. The image forming apparatus of claim 1, wherein the toner comprises the charge controlling agent in an amount of from 0.2 to 5 parts by weight.

14. The image forming apparatus of claim 1, wherein the toner has a charge quantity of from −100 to 10 μc/mg.
